(19) United States
(12) Patent Application Publication
(10) Pub. No.: US 2016/0288306 A1
(43) Pub. Date: Oct. 6, 2016

(54) HYDRAULIC HAMMER HAVING SELF-CONTAINED GAS SPRING

(71) Applicant: Caterpillar Inc., Peoria, IL (US)

(72) Inventor: Lauritz Phillip PILLERS, II, Waco, TX (US)

(73) Assignee: Caterpillar Inc., Peoria, IL (US)

(21) Appl. No.: 14/679,499

(22) Filed: Apr. 6, 2015

(51) Int. Cl. B25D 9/06; F16F 9/04; B25D 17/24

(52) U.S. Cl. CPC B25D 9/06; B25D 17/245; F16F 9/0409; F16F 9/0418; F16F 9/049

(57) ABSTRACT

A gas spring is disclosed for use with a hammer. The gas spring may have a body with a central axis, and a bore aligned with the central axis and extending to at least one open axial end of the body. The gas spring may also have a plurality of gas chambers fully enclosed by the body and isolated from each other. The bore may have a flexible annular wall in communication with the plurality of gas chambers.

### TECHNICAL FIELD

The present disclosure is directed to a hammer and, more particularly, to a hydraulic hammer having a self-contained gas spring.

### BACKGROUND

A hydraulic hammer, often referred to as a breaker, can he attached to various machines for the purpose of milling asphalt, concrete, stone, and other construction materials. A conventional hammer includes a work tool (e.g., a chisel) having a tip that engages the material to be milled, and a reciprocating piston that is repetitively extended from the hammer by pressurized fluid to hit against a base end of the work tool. After each engagement with the work tool, the piston retracts back into the hammer.

In conventional hammers, an open gas-filled cavity is located inside the hammer at a base end of the piston. The gas (typically nitrogen) inside of the cavity functions as a spring to absorb energy from the piston during the retracting stroke when the base end of the piston enters the chamber and compresses the gas, and then return energy to the piston during the next extending stroke through expansion of the gas against the base end of the piston. One problem associated with this arrangement involves leakage of the gas out of the cavity. The gas leaks through annular clearances around the piston, and the cavity must be periodically recharged in order to maintain performance of the hammer.

An alternative design is disclosed in U.S. Pat. No. 4,380,901 of Rautimo et al. that issued on Apr. 26, 1983 (“the '901 patent”). In particular, the '901 patent discloses a hydraulic percussion machine having a body, a piston disposed within the body, and an accumulator disposed in axial alignment with and above the piston. The accumulator has a gas-filled chamber separated by a membrane from a liquid-filled chamber. The liquid-filled chamber is in communication with a base end of the piston via a plurality of passages, and the gas-filled chamber is isolated from the piston. The accumulator stores piston stroke energy, which accelerates the piston for striking against a tool disposed at a working end of the machine.

Although the alternative design of the '901 patent may suffer less gas leakage around the piston, it may still be problematic. In particular, the gas-filled chamber may still leak through other pathways in the hammer and need to be periodically replenished. In addition, it may be possible for the diaphragm to leak around its periphery, allowing the liquid and gas to mix and contaminate the machine.

The disclosed hammer is directed to overcoming one or more of the problems set forth above and/or other problems of the prior art.

### SUMMARY

In one aspect, the present disclosure is directed to a gas spring. The gas spring may include a body with a central axis, and a bore aligned with the central axis and extending to at least one open axial end of the body. The gas spring may also include a plurality of gas chambers fully enclosed by the cylindrical body and isolated from each other. The bore may have a flexible annular wall in communication with the plurality of gas chambers.

In another aspect, the present disclosure is directed to another gas spring. This gas spring may include a cylindrical body having a central axis and a bore aligned with the central axis and extending to at least one open axial end of the cylindrical body. The gas spring may also include a plurality of gas chambers fully enclosed by the cylindrical body. The cylindrical body may be a monolithic structure formed as a single component via a 3-D printing process in an atmosphere of gas, at least a portion of which is to be entombed in the plurality of gas chambers. The bore may have a flexible annular wall in communication with the plurality of gas chambers, such that outward flexing of the annular wall compresses the gas in the plurality of gas chambers.

In yet another aspect, the present disclosure is directed to a reciprocating hammer. The reciprocating hammer may include a frame forming a cylinder bore and having a first end and a second end, a bushing disposed within the first end of the frame, and a work tool reciprocatingly disposed in the bushing. The reciprocating hammer may also include a piston reciprocatingly disposed in the cylinder bore and having a working end configured to engage the work tool and a control end located opposite the working end. The reciprocating hammer may further include a head removably connected to the second end of the frame, and a self-contained gas spring fluidly connected to the control end of the piston.

### BRIEF DESCRIPTION OF THE DRAWINGS

FIG. 1 is an isometric illustration of a machine equipped with an exemplary disclosed hydraulic hammer;

FIGS. 2 and 3 are cross-sectional illustrations of an exemplary portion of the hydraulic hammer of FIG. 1; and

FIGS. 4-7 are cutaway illustrations of exemplary disclosed gas springs that may form a portion of the hydraulic hammer of FIGS. 1-3.

### DETAILED DESCRIPTION

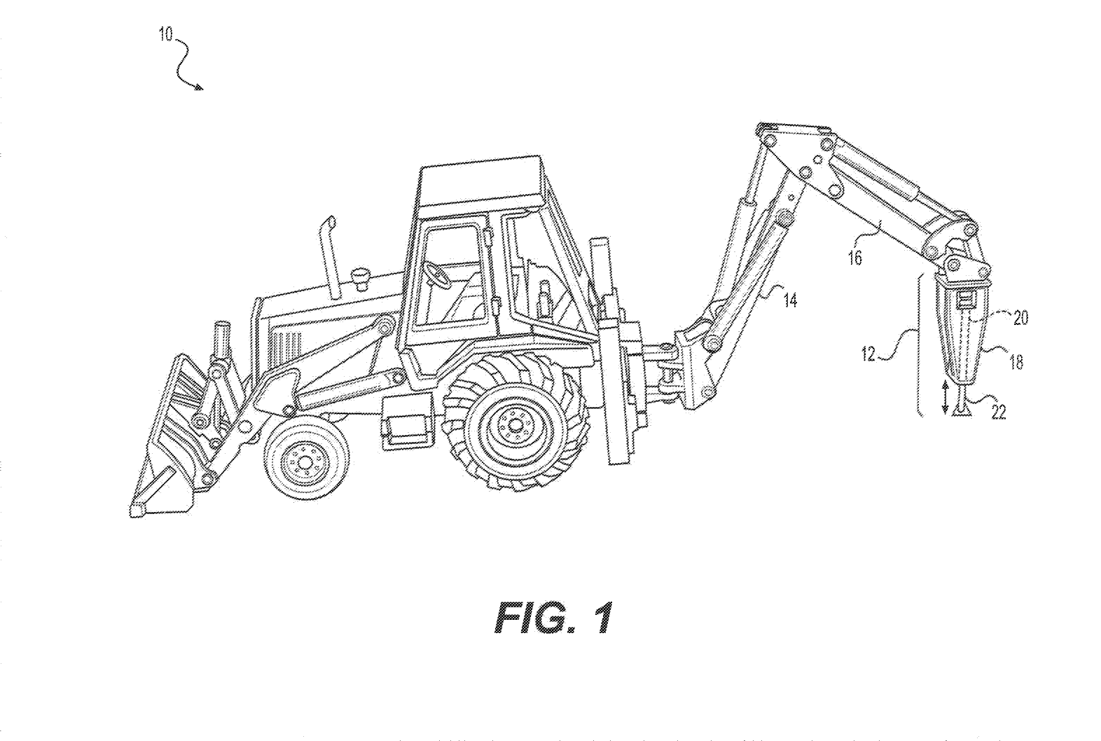

FIG. 1 illustrates a machine 10 having an exemplary disclosed hammer 12 connected thereto. Machine 10 may be configured to perform work associated with a particular industry, such as mining or construction. For example, machine 10 may be a backhoe loader (shown in FIG. 1), an excavator, a skid steer loader, or another machine. Hammer 12 may be pivotally connected to machine 10 through a boom 14 and a stick 16, such that hammer 12 can be lifted, moved in and out, curled, and swung left-to-right. It is contemplated that a different linkage arrangement may alternatively be utilized, if desired, to move hammer 12 in another manner.

Hammer 12 may include an outer shell 18, and an actuator assembly 20 located within outer shell 18. Outer shell 18 may connect actuator assembly 20 to stick 16 and provide protection for actuator assembly 20. A work tool 22 may be operatively connected to an end of actuator assembly 20, opposite stick 16, and protrude from outer shell 18. It is contemplated that work tool 22 may have any configuration known in the art. In the disclosed embodiment, work tool 22 is a chisel bit.

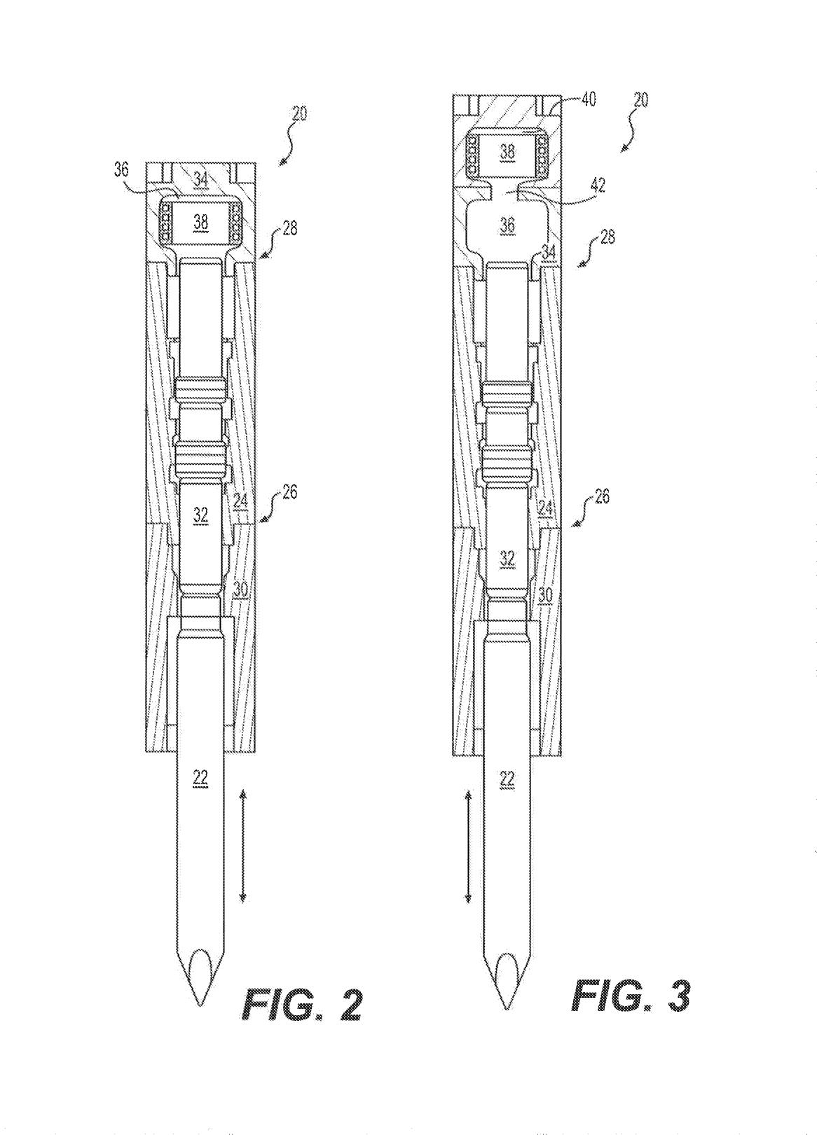

As shown in the cross-sectional illustration of FIG. 2, actuator assembly 20 may include a frame or main housing 24 having a bottom end 26 and an opposing top end 28. A bushing 30 may be connected to frame 24 at bottom end 26. Bushing 30 may be configured to reciprocatingly receive work tool 22. A piston 32 may be disposed within a bore of frame 24, and a head 34 may close off top end 28 of frame 24, thereby enclosing piston 32. As is known in the art, hydraulic fluid may be selectively directed to different hydraulic surfaces of piston 32 inside of the bore of frame 24 to cause piston 32 to extend from frame 24 and engage work tool 22 or to retract away from work tool 22 back into frame 24.

Head 34 may have formed therein a gas cavity (“cavity”) 36. Cavity 36 may be open to frame 24 and configured to receive a control end of piston 32 (i.e., an end opposite a working end that engages work tool 22). In particular, during the retracting stroke, the control end of piston 32 may enter cavity 36, thereby reducing a volume of cavity 36 and causing the gas contained therein to compress. In the disclosed embodiment, the gas in cavity 36 is air, it is contemplated, however, that another gas (e.g., primarily nitrogen) could alternatively be disposed in cavity 36, if desired.

In addition to providing a space to hold air (or another gas), cavity 36 of head 34 may also house a self-contained gas spring 38. The air inside cavity 36, together with gas spring 38, may function as an energy recovery mechanism. In particular, as piston 32 moves through its retracting stroke and compresses the air inside cavity 36, the compressed air may exert an outward force on gas spring 38 causing gas spring 38 to also compress. The energy required to compress the air and to compress gas spring 38 may be absorbed from piston 32 during the end of the compression stroke, thereby slowing piston 32 in preparation for a change in direction. Then, during the ensuing extending stroke, after piston 32 has changed travel directions, a majority of the absorbed energy may be returned to piston 32, causing piston 32 to accelerate in the extending direction. It should be noted that some energy absorbed from piston 32 may be lost in the form of heat due to inherent inefficiencies of hammer 12.

FIG. 3 illustrates an alternative embodiment of actuator assembly 20. Like the embodiment of FIG. 2, actuator assembly 20 of FIG. 3 may also include frame 24, bushing 30, work tool 22, and head 34. However, in contrast to the embodiment of FIG. 2, actuator assembly 20 of FIG. 3 may include an additional spring cavity 40 that is fluidly connected to gas cavity 36 of head 34 via a passage 42. Spring cavity 40 may be configured to house gas spring 38, and passage 42 may allow air compressed by the retracting motion of piston 32 in cavity 36 to enter into spring cavity 40 and cause the compression of gas spring 38 in the same manner described above with respect to the embodiment of FIG. 2.

By having a separate spring cavity 40, packaging of actuator assembly 20 may be more flexible. In particular, although spring cavity 40 is shown as being mechanically connected to head 34 and located at an end of actuator assembly 20 in axial alignment with piston 32, it may be possible for spring cavity 40 to be located elsewhere within hammer 12. That is, as long as passage 42 can be established between gas cavity 36 and spring cavity 40, spring cavity 40 may be located anywhere on or even near (e.g., outside of) hammer 12. This configuration may also allow for retrofit of existing hammers with gas spring 38 when the original head is not sized to internally receive gas spring 38.

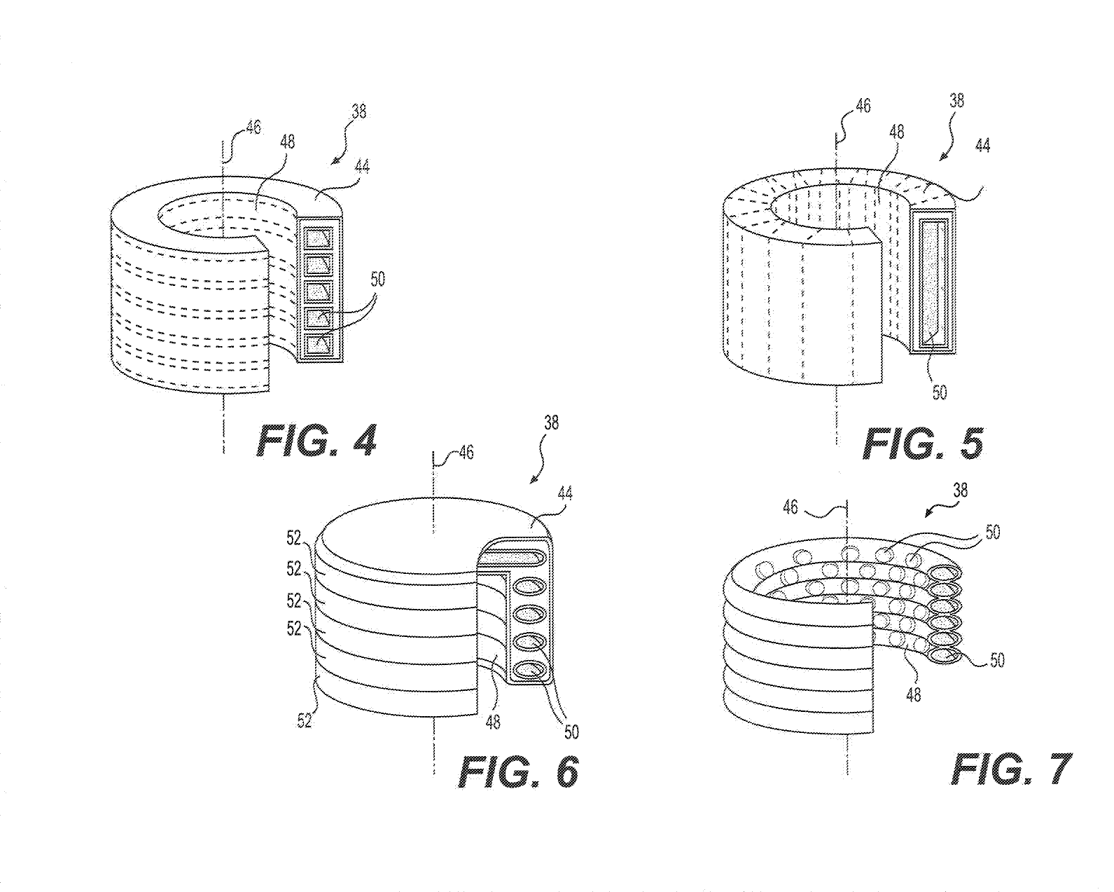

An exemplary gas spring 38 is illustrated in FIG. 4, As seen in this figure, gas spring 38 may include a body 44 having a central axis 46 and a bore 48 extending in an axial direction of body 44 and aligned with axis 46. In one example, body 44 is generally cylindrical and configured to conform somewhat to the internal shape of the component housing body 44 (e.g., gas cavity 36 or spring cavity 40). In the embodiment of FIG. 4, bore 48 is open to body 44 at two opposing ends, and bore 48 is configured to receive the control end of piston 32 (referring to FIG. 2). An annular clearance space may be maintained between an internal wall of bore 48 and an external wall of piston 32, such that piston 32 does not mechanically engage body 44 at any time during operation of hammer 12.

A plurality of gas chambers 50 may be formed inside body 44. In the disclosed embodiment, each gas chamber 50 is isolated from the remaining gas chambers 50. However, it is contemplated that one or more of gas chambers 50 could be fluidly interconnected, if desired. Gas chambers 50 may he filled with a compressible gas, for example a non-reactive gas such as nitrogen (or a mixture that is primarily nitrogen). It may be possible for gas chambers 50 to alternatively be filled with air in some applications. In the disclosed embodiment, body 44 is a monolithic structure formed as a single component via a 3-D printing process in an atmosphere of nitrogen (or air), such that during the formation process the nitrogen is entombed in gas chambers 50. It may be possible, however, for body to be formed via an alternative process (e.g., molding), if desired.

In the example of FIG. 4, each gas chamber 50 has a toroidal shape a generally ring-like or donut shape), with a square cross-section. With this configuration, each gas chamber 50 may be located at a different axial location in the length direction of body 44 along axis 46. The inner annular wall of bore 48 may be common to each of gas chambers 50 and, as the air pressure in gas cavity 36 or spring cavity 40 increases, the inner annular all may flex outward into gas chambers 50. This outward flexing of the inner bore wall may effectively decrease a volume of each gas chamber 50, thereby causing the nitrogen inside gas chamber 50 to compress. In one example, body 44 (including the inner annular wall of bore 48) is fabricated from a resilient material, such as natural rubber or a urethane, that provides the desired flexibility. The material may have a type A-Shore Durometer of about 70-95.

An alternative embodiment of gas spring 38 is shown in FIG. 5. Like the embodiment of FIG. 4, gas spring 38 of FIG. 5 may also include body 44 having axis 46, bore 48, and gas chambers 50. However, in contrast to the embodiment of FIG. 4, gas chambers 50 of FIG. 5 may be oriented and shaped differently. In particular, gas chambers 50 of FIG. 5 may be elongated, straight, and oriented in the axial direction of body 44 (i.e., oriented generally parallel to axis 46). In addition, a cross-section of gas chambers 50, in the embodiment of FIG. 5, may be generally trapezoidal. Each of these gas chambers 50 may be located at the same general axial location, but each located at a different radial location around the periphery of body 44.

Another alternative embodiment of gas spring 38 is shown in FIG. 6. Like the embodiments of FIGS. 4 and 5, gas spring 38 of FIG. 6 may also include body 44 having axis 46, bore 48, and gas chambers 50. However, in contrast to the embodiments of FIGS. 4 and 5, body 44 and gas chambers 50 of FIG. 6 may be oriented and shaped differently. In particular, in the embodiment of FIG. 6, body 44 is no longer a monolithic structure and has only a single open end. That is, body 44 may be an assembly of a plurality of rings 52 that are each fabricated separately and stacked on top of each other in the axial direction. By using multiple separate rings 52, the energy recovery function provided by gas spring 38 may be selectively tailored for different applications by assembling a different number, shape, and/or size of rings 52 together. In addition, bore 48 may not extend up through the final ring 52 located at the closed end of body 44. In other words, the final ring 52 may house a disk-shaped gas chamber 50 that extends completely across bore 48, thereby closing off bore 48 at one end. Gas chamber 50 in this final ring 52 may be isolated from the remaining gas chambers 50.

In the embodiment of FIG. 6, at least one gas chamber 50 may be completely encased within each of rings 52, and have a toroidal shape. In addition, a cross-section of gas chambers 50 (i.e., all but the gas chamber 50 located in the final ring 52) in the embodiment of FIG. 6 may be rounded (e.g., circular or elliptical).

Another alternative embodiment of gas spring 38 is shown in FIG. 7. Like the embodiments of FIGS. 4-6, gas spring 38 of FIG. 7 may also include body 44 having axis 46, bore 48, and gas chambers 50. However, in contrast to the embodiments of FIGS. 4-7, gas chambers 50 of FIG. 6 may be protrude radially inward at multiple locations such that gas chambers 50 take on a “bubbled” appearance inside bore 48. In this example, the formation of body 44 may be tightly controlled such that the walls of body 44 separating the various chambers 50 may have the same general thickness, allowing even flexing of the walls. This may help to improve performance consistency and longevity of gas spring 38.

It should be noted that, while particular features are shown in each of the different gas spring embodiments, each embodiment could include any one or more of the different features. For example, it may be possible for body 44 of FIG. 4 to be made from an assembly of rings 52, if desired. Alternatively, the final ring 52 of FIG. 6 could be added to or integral with the monolithic structure of either or both of FIGS. 4 and 5 to close off bore 48. In addition, any of the different embodiments could have square, rounded, or trapezoidal cross-sections. Other combinations may also be possible.

### INDUSTRIAL APPLICABILITY

The disclosed hydraulic hammer may have high efficiency, longevity, and low operating costs. Specifically, because the disclosed hydraulic hammer may include a self-contained gas spring that does not have openings that could leak, the hammer may continue to operate as designed throughout its life. In other words, the efficiency of the hammer should not degrade over time, as gas spring 38, being self-contained, should not leak. In addition, because the disclosed hammer may not need to be periodically recharged with high-pressure gas, the life of the disclosed hammer should be increased and have less associated downtime and maintenance activities. In addition, because the disclosed hammer may not need to be filled with high-pressure nitrogen, but instead may use air at atmospheric conditions, initial cost and maintenance cost of the hammer may be low.

It will be apparent to those skilled in the art that various modifications and variations can be made to the hammer and/or gas spring of the present disclosure. Other embodiments of the hammer and/or gas spring will be apparent to those skilled in the art from consideration of the specification and practice of the method and system disclosed herein. For example, it is contemplated that the disclosed gas spring could be used in systems not associated with hydraulic hammers, if desired. For instance, the disclosed gas spring could be used inside of a shock absorber of a strut for a mobile machine. It is intended that the specification and examples be considered as exemplary only, with a true scope of the disclosure being indicated by the following claims and their equivalents.

What is claimed is:

1. A gas spring, comprising:
a body having a central axis and a bore aligned with the central axis and extending to at least one open axial end of the body; and
a plurality of gas chambers fully enclosed by the body and isolated from each other,
wherein the bore has a flexible annular wall in communication with the plurality of gas chambers.

2. The gas spring of claim 1, wherein the bore extends to two opposing axial ends of the body.

3. The gas spring of claim 1, wherein the body is a monolithic structure formed as a single component by a 3-D printing process in an atmosphere of gas, a portion of which is to be entombed in the plurality of gas chambers.

4. The gas spring of claim 1, wherein at least one of the plurality of gas chambers has a toroidal shape.

5. The gas spring of claim 1, wherein at least one of the plurality of gas chambers has a square cross-section.

6. The gas spring of claim 1, wherein at least of the plurality of gas chambers has a rounded cross-section.

7. The gas spring of claim 1, wherein each of the plurality of gas chambers is located at a different location along the central axis of the body.

8. The gas spring of claim 1, wherein each of the plurality of gas chambers is located at a different radial location around the central axis of the body.

9. The gas spring of claim 1, wherein each of the plurality of gas chambers extends in a lengthwise direction generally parallel with the axis of the body.

10. The gas spring of claim 1, wherein at least of the plurality of gas chambers has a trapezoidal cross-section.

11. The gas spring of claim 1, wherein:
the body has only one open axial end; and
the gas spring further includes an additional gas chamber located opposite the one open axial end and isolated from the plurality of gas chambers.

12. The gas spring of claim 11, wherein the additional gas chamber extends across the bore.

13. The gas spring of claim 1, wherein the body is divided into a plurality of stacked rings each formed as a separate component, each of the plurality of stacked rings enclosing at least one of the plurality of gas chambers.

14. The gas spring of claim 1, wherein the flexible annular wall is fabricated from natural rubber.

15. The gas spring of claim 1, wherein the plurality of gas chambers extend inward to form a plurality of bubbles inside the bore.

16. A gas spring, comprising:
a cylindrical body having a central axis and a bore aligned with the central axis and open to at least one axial end of the cylindrical bore; and
a plurality of gas chambers fully enclosed by the cylindrical body,
wherein:
the cylindrical body is a monolithic structure formed as a single component via a 3-D printing process in an atmosphere of gas, a portion of which is to be entombed in the plurality of gas chambers; and
the bore has a flexible annular wall in communication with the plurality of gas chambers, such that outward flexing of the annular wall compresses the gas in the plurality of gas chambers.

17. A reciprocating hammer, comprising:
a frame forming a cylinder bore and having a first end and a second end;
a bushing disposed within the first end of the frame;
a work tool reciprocatingly disposed in the bushing;
a piston reciprocatingly disposed in the cylinder bore and having a working end configured to engage the work. tool and a control end located opposite the working end;
a head removably connected to the second end of the frame; and
a self-contained gas spring fluidly connected to the control end of the piston.

18. The reciprocating hammer of claim 17, wherein:
the head includes an open gas cavity configured to receive the control end of the piston; and
the self-contained gas spring is disposed in the open gas cavity.

19. The reciprocating hammer of claim 18, wherein the self-contained gas spring encloses a first gas that is different than a second gas located in the open gas cavity.

20. The reciprocating hammer of claim 19, wherein:
the first gas is primarily nitrogen; and
the second gas is air.

21. The reciprocating hammer of claim 19, wherein;
the air is compressed by the piston during a retracting stroke; and
the compressed air exerts a force on the self-contained gas spring causing the nitrogen to be compressed.

22. The reciprocating hammer of claim 17, wherein the self-contained gas spring has an open end configured to receive the control end of the piston.

23. The reciprocating hammer of claim 22, wherein a clearance is maintained between the piston and the self-contained gas spring during operation of the hammer.

24. The reciprocating hammer of claim 17, wherein:
the head includes an open gas cavity configured to receive the control end of the piston;
the reciprocating hammer further includes:
a spring cavity separate from the open gas cavity; and
a passage connecting the spring cavity to the open gas cavity; and the self-contained gas spring is disposed in the spring cavity.

25. The reciprocating hammer of claim 24, wherein the self-contained gas spring is generally cylindrical and configured to conform to an internal shape of the spring chamber.

26. The reciprocating hammer of claim 17, wherein the self-contained gas spring is disposed in axial alignment with the piston.

27. The reciprocating hammer of claim 17, wherein the self-contained gas spring is generally cylindrical and configured to conform to an internal shape of the head.
